(19) United States
(12) Patent Application Publication
(10) Pub. No.: US 2020/0158227 A1
(43) Pub. Date: May 21, 2020

(54) BEARING TYPE GEAR SYSTEM FOR UNDERGROUND MINING EQUIPMENT

(71) Applicant: Winfred Lee Shrewsbury, KEGLEY, WV (US)

(72) Inventor: Winfred Lee Shrewsbury, KEGLEY, WV (US)

(21) Appl. No.: 16/194,363

(22) Filed: Nov. 18, 2018

(51) Int. Cl. F16H 57/029; F16C 19/54; F16C 33/66; F16H 57/04

(52) U.S. Cl. CPC F16H 57/029; F16C 19/548; F16C 33/6603; F16H 2048/423; F16C 33/6637; F16C 2361/61; F16H 57/04

(57) ABSTRACT

A bearing type gear system for use with low seam crawler drive for underground mining equipment. The Bearing type gear system is comprised generally of a shaft, a set of multiple lubrication reservoirs, a needle bearing set or sets, a gear or gears, and gear teeth on the gear(s). As lubrication is sent into the shaft and gear area, the reservoirs along the shaft will pick up and hold portions of the lubrication. The reservoirs of the design herein, holding lubrication, can then help distribute the lubrication into the bearings over a greater amount of time. The reservoirs are of a number and location of intervals to provide sufficient lubrication to the entire surface of the shaft of the reservoirs as the shaft turns.

### TECHNICAL FIELD OF THE INVENTION

The present invention relates to mining equipment, and more specifically to improved bearing support systems for crawler drives for mining operations, such as, for example, low seam underground mining.

### BACKGROUND OF THE INVENTION

When a low seam of coal or mineral needs to be mined, the height limits of the seam presents a specific mining challenge. To access low seams, low profile machines, often low seam planetary traction units, are often used to facilitate low seam underground mining operations such as, e.g., high wall mining. Rather than miners using mining tunnels to recover coal, the lower profile crawler with forward cutting heads, or like equipment capable of breaking up the seam, are sent into the seam. These cutting units are typically controlled by a control unit that is behind the unit and outside the seam, and the crawlers are typically propelled running on tracks.

It is known that for facilitating the turning of gears for cutting equipment such as cutting heads and drive train components, bearings, specifically needle bearings, are functionally superior to a bushing and pin system for minimizing friction. The roller action of bearings results in less friction than a bushing and pin system and so superior results. Sufficient lubrication of gears is of serious concern, as the gears might exert a pressure of up to 30,000 foot pounds.

Accordingly, these units would be improved if they could use bearings rather than a bushing and pin arrangements. However, these low-profile machines, because of the nature of the seams they are designed to access, have height limits. The height limits of these units typically rule out the use of normal bearing diameters. Needle bearings are so low profile that they are very difficult to lubricate if placed in these machines. With this type of bearing there is not enough clearance with these machines to successfully let an adequate supply of lubricating oil reach into the bearings, so that due to restricted lubrication oil flow, bearings cannot successfully be used. If the bearings are not adequately lubricated with enough frequency, they will quickly burn out. This will result in the need to remove the bearings for maintenance, stopping the machines from mining. Thus far, this happens often enough to make bearings unworkable.

Bushings, which are less in need of constant lubrication, are settled for instead. Bushings/pin arrangements have instead been used for at least 30 years without improvement.

Turning to prior art FIG. 1, a basic design of the friction reduction arrangement now typically used for low-profile equipment is shown. FIG. 1 features a typical pin and bushings arrangement 1. A pin 3, herein a bronze pin, is used with a bushing 7 to help turn a gear 5, herein a straight bore gear typically of heat-treated steel, having a clearance of 0.007 to 0.012 inches. The bronze pin 3 may be thru-slotted with one or more lubrication channels to facilitate lubrication. The bushing 7 in this embodiment has a hardness of 60 Rockwell C and the pin 3 is 38/40 Rockwell C, and the softer part wears rapidly compared to the harder part.

Because of the low profile of needle bearing systems, lubrication reservoirs such as those herein would not lubricate bearings sufficiently, likely resulting in destruction of the bearings.

However, the use of bushings though necessary because of this lubrication issue with bearings, has its issues and is not preferred. The use of bushings results in increased friction and therefore a less efficient rotational motion for the shafts these machines turn, an increased need for maintenance of the bushings and related parts, and an overall reduction in the life of the crawlers.

### SUMMARY

A bearing type gear system for use with low seam crawler drive for underground mining equipment is shown and illustrated.

The Bearing type gear system is comprised generally of a shaft, a set of multiple lubrication reservoirs (which are concavities or indentations), a needle bearing set or sets, a gear or gears, and gear teeth on the gear(s).

The invention herein has several features that help get lubrication to the bearings to make the bearings compatible with this type of cutting equipment. As lubrication is sent into the shaft and gear area, the reservoirs along the shaft will pick up and hold portions of the lubrication. With a shaft without reservoirs, as is known in the art, the lubrication has nowhere to get purchase and quickly disappears. However, the reservoirs of the design herein, holding lubrication, can then help distribute the lubrication into the bearings over a greater amount of time. Additionally, reservoirs located on each end of the gear also pick up the lubrication and can feed it to the bearings, further into the cavities between the individual bearings. The lubricant in this embodiment can be comprised of any known or acceptable lubricant in the art, such as, as in this embodiment, a lubrication oil. The multiple reservoir design is a special reservoir design which helps to get lubricant to the bearings and does not impede the function of the bearings

Further, apertures through the gear and to the shaft can be provided by pre-drilling between the gear teeth or at other functional points. As lubricant is sent into the gear area, some of the lubricant cam proceed through the apertures and into the shaft area, to the reservoirs, to further lubricate the bearings, in this embodiment, the apertures are located on a protruding bearing wall but can of any number and location wherein they are functionally effective. The bearing wall protrudes above the floor upon which the bearing sets rest and helps secure the bearing sets.

As the gears of a planetary gear system rotate, the shaft is turned directly and turns the gear, or as in this embodiment, the teeth of an opposing gear turn the gear, turning the shaft. The reservoirs are located throughout the surface of the shaft. The reservoirs are distributed, at least in part, in a non-linear manner about the surface. The reservoirs are of a number and location of intervals to provide sufficient lubrication to the entire surface of the shaft of the reservoirs as the shaft turns. The lubricant is forced into the reservoirs and from there, distributed between the bearings to further lubricate the bearing sets

In one embodiment, the lubricant is applied to the outer portion of the gear and via the gear lubrication apertures, is forced onto the surface of the shaft, where the reservoirs help hold and distribute the lubricant to the bearings. This extra lubrication provides additional lubrication to the bearings, which reduces friction and will increase the overall life of the system.

Another feature of the bearing system, which can be present and further improve lubrication, is gear washers with apertures. The gear has gear washers in contact with the gear. The washers each have aperture and in one embodiment, a pair of respective apertures. When lubricant is applied to the gear area, even more of the lubricant is able, by going through the apertures to get into the lubrication reservoirs and thereby the bearing sets, supplying them with more lubrication.

With the ability to use bearings, there is more contact area when torque is applied. This spreads the pressure over more of an operating area than with a bushing and pin type system, reducing wear. This reduction of wear and the need for maintenance, in turn, increases the life of the unit.

With the gear lubrication design disclosed herein, the bearing system can be properly lubricated. Accordingly, with this invention, a bearing type system can be used with the gears herein, and with reduced friction and wear on machinery, and can double or more the life of the friction-reducing assembly.

### BRIEF DESCRIPTION OF THE DRAWINGS

The detailed description particularly refers to the accompanying figures in which:

FIG. 1 is a perspective view, in partial cutaway, of a prior art embodiment

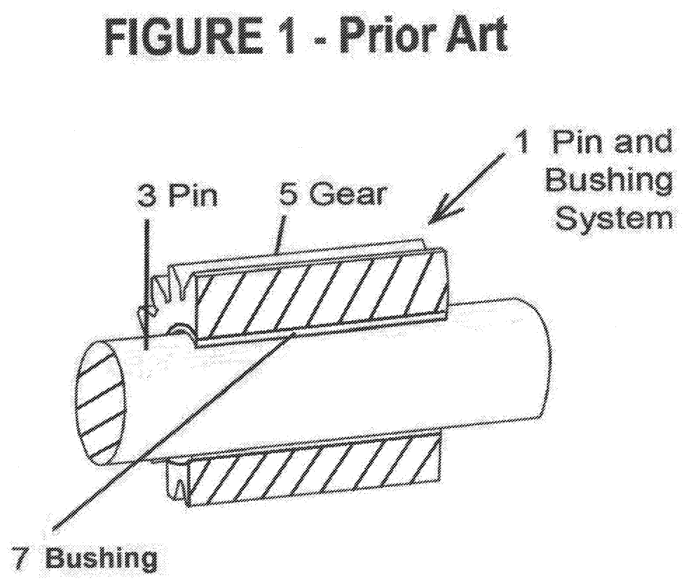

FIG. 2 is a slight perspective view, in partial cutaway, of an embodiment of the invention.

FIG. 3 is a slight perspective view of a portion of the embodiment of FIG. 2

FIG. 4 is a slight perspective view of a portion of the embodiment of FIG. 2

FIG. 5 is a slight perspective view of a portion of the embodiment of FIG. 2

FIG. 6 is a slight perspective view similar to FIG. 2, in partial cutaway, of an embodiment of the invention emphasizing a feature of the invention.

### DETAILED DESCRIPTION OF PREFERRED EMBODIMENTS

Other objects, features and advantages of the invention will become apparent from a consideration of the following detailed description and the accompanying drawings. The following descriptions are made referring to the figures, wherein like reference numbers refer to like features throughout this description. Not all numbers appearing in one figure are necessarily present in another.

For the purposes of promoting and understanding the principals of the invention, reference will now be made to one or more illustrative embodiments. The bearing and support apparatus herein of the present invention may comprise one or more of the following features and combinations thereof as described here. Crawlers are complex pieces of equipment and components such as gears and bearings have been reduced to representative items necessary for understanding of the current invention and do not represent all of the possible components or possible combination of components in the cutting head of a crawler.

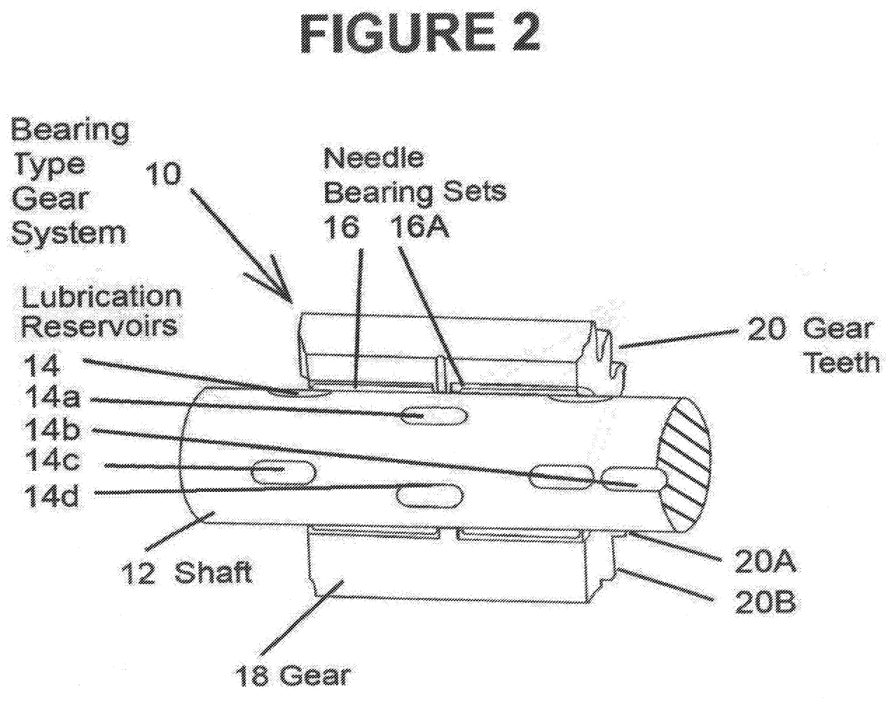

Turning to FIG. 2, a bearing type gear system 10 for use with crawler drive for underground mining equipment is shown and illustrated. This is a new bearing layout design for the gearing of a low profile crawler, such as the planetary gears in a low profile planetary system.

The Bearing type gear system 10 is comprised generally of a representative shaft 12, a set of multiple lubrication reservoirs, which are concavities or indentations, represented herein as 14, 14a, 14b, 14c, 14d, needle bearing sets, represented herein as 16, 16a, a representative gear 18, and gear teeth represented herein as 20, 20a, 20b on the gear 18.

The multi-reservoir shaft 12, the sets of needle bearings 16, 16a, and gear 18 are shown in this figure. The gear 18 component is featured in a partial cutaway view to provide greater visibility of other components. The invention herein has several features that help get lubrication to the bearings 16, 16a to make the bearings compatible with this type of cutting equipment. As lubrication is sent into the shaft and gear area, the reservoirs 14, 14a, 14b, 14c, 14d shown on the shaft will pick up and hold portions of the lubrication. With a smooth shaft without reservoirs, as is known in the art, the lubrication has nowhere to get purchase and quickly disappears. However, the reservoirs 14, 14a, 14b, 14c, 14d of the design herein, holding lubrication, can then help distribute the lubrication into the bearings over a greater amount of time. The reservoirs 14, 14a, 14b, 14c, located on each end of the gear also pick up the lubrication and can feed it to the bearings 16, 16a, further into the cavities, between the individual bearings 22, 22a, 22b. The lubricant in this embodiment can be comprised of any known or acceptable lubricant in the art, such as, as in this embodiment, a lubrication oil. The multiple reservoir design is a special reservoir design which helps to get lubricant to the bearings and does not impede the function of the bearings

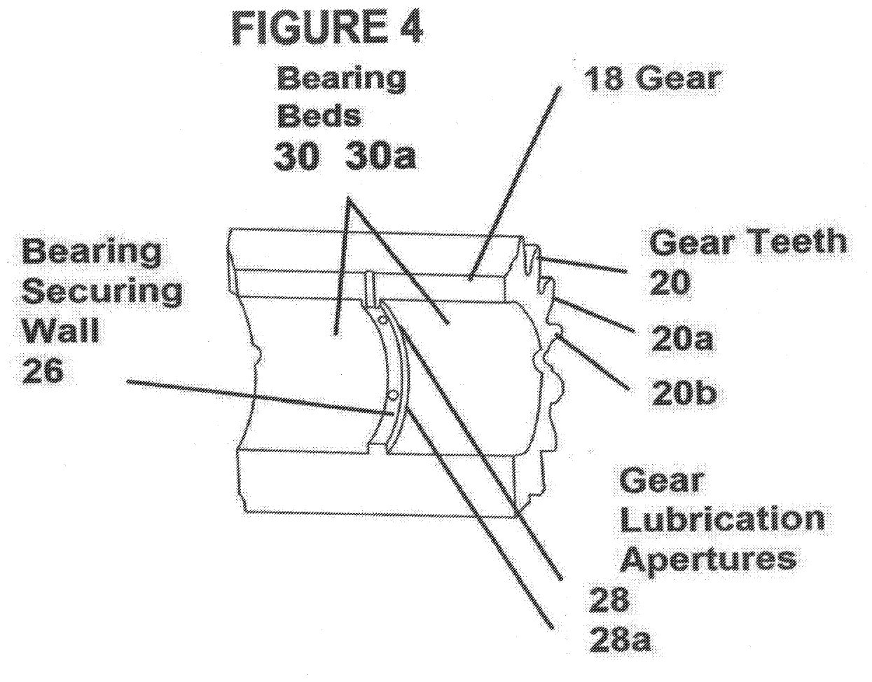

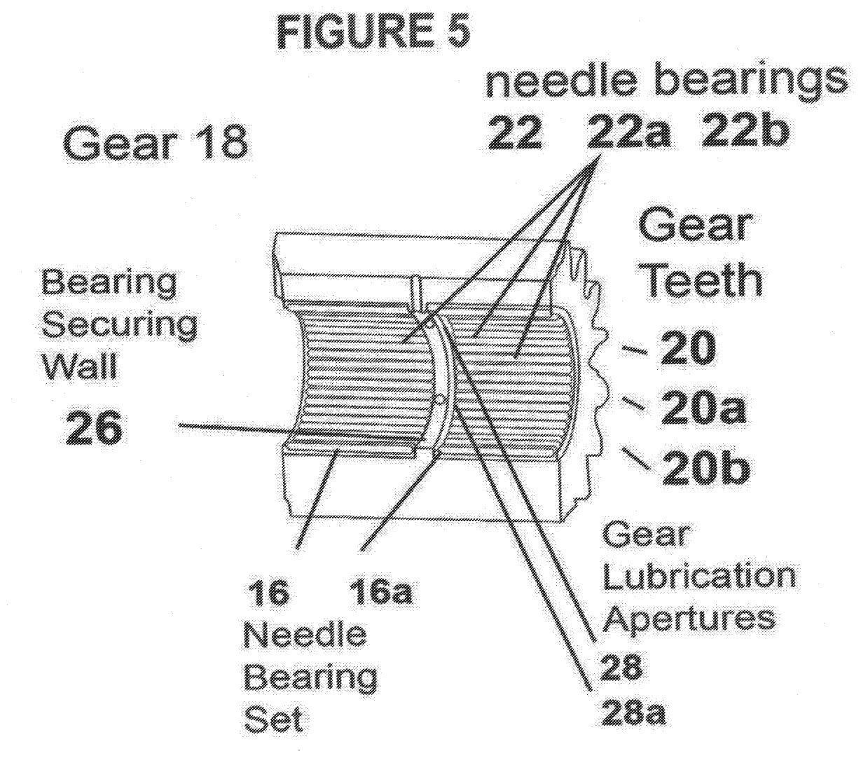

Turning briefly to FIGS. 4-5, at least one aperture, and in this embodiment a pair of apertures, represented herein by 28, 28a, are provided through the gear 18 and to the area of the shaft 12. The apertures 28, 28a, can be provided by pre-drilling between the gear teeth 20, 20a, 20b or at other functional points. As lubricant is sent into the gear 18 area, some of the lubricant cam proceed through the apertures 28, 28a and into the shaft area, to the reservoirs 14, 14a, 14b, 14c, 14d, to further lubricate the bearing sets 16, 16a. The apertures 28, 28a in this embodiment are located on the protruding bearing wall 26. The bearing wall 26 protrudes above the floor upon which the bearing sets 16, 16a rest, and helps secure the bearing sets 16, 16a.

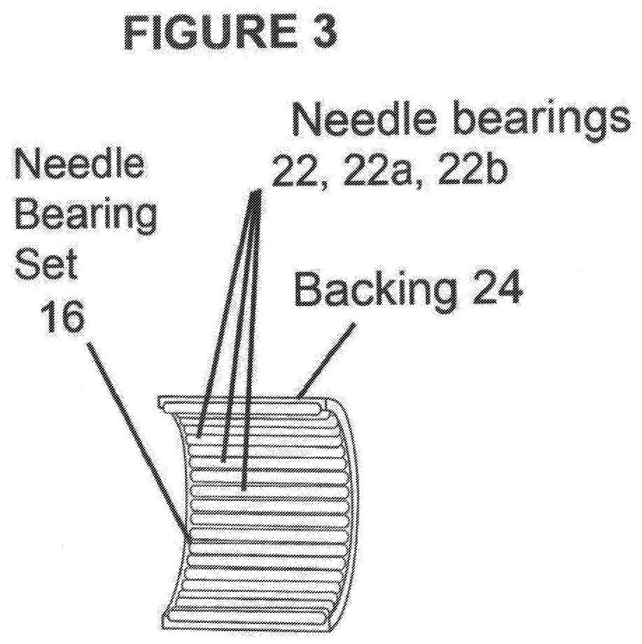

Turning to FIGS. 3-5, some specific components of the invention are shown.

Turning specifically to FIG. 3, an individual needle bearing set 16 is depicted. The needle bearing set 16 is comprised of a set of needle bearings 22, 22a, 22b needing lubrication. The bearing set 16 has a backing 24 which secures the needle bearings 22, 22a, 22b within the bearing set 16.

Turning to FIG. 4 as well as FIG. 2, the gear 18, which is designed to work with the needle bearing system herein, is again shown in a partial cutaway view. The gear 18 is further comprised of a set of bearing beds 30, 30a. The bearing beds 30, 30a are provided to be of a sufficient size for the bearing sets 16, 16a, to rest in securely. Bearing walls, represented herein as bearing wall 26, serve to divide the bed area into the individual bearing beds 30, 30a to secure the bearing sets 16, 16a.

Turning also to FIG. 5, the gear 18 is shown with the bearing sets 16, 16a, resting in the bearing beds.

Returning to FIG. 2, the operation of the bearing type gear system will be discussed. As the gears of a planetary gear system rotate, the shaft 12 is turned directly and turns the gear 18, or as in this embodiment, the teeth of an opposing gear turn the gear 18, turning the shaft 12. The reservoirs 14, 14a, 14b, 14c, 14d, are located throughout the surface of the shaft 12. The reservoirs are distributed, at least in part, in a non-linear manner about the surface. The reservoirs 14, 14a, 14b, 14c, 14d, are of a number and location of intervals so as to provide sufficient lubrication to the entire surface of the shaft of the reservoirs 14, 14a, 14b, 14c, 14d, as the shaft 12 turns. The lubricant is forced into the reservoirs and from there, distributed between the bearings 20, 20a, 20b, to further lubricate the bearing sets 16, 16a. In one embodiment, the lubricant is applied to the outer portion of the gear 18 and via the gear lubrication apertures, is forced onto the surface of the shaft 12, where the reservoirs 14, 14a, 14b, 14c, 14d, help hold and distribute the lubricant to the bearings 16, 16a. This extra lubrication provides additional lubrication to the bearings 16, 16a, which reduces friction and will increase the overall life of the system.

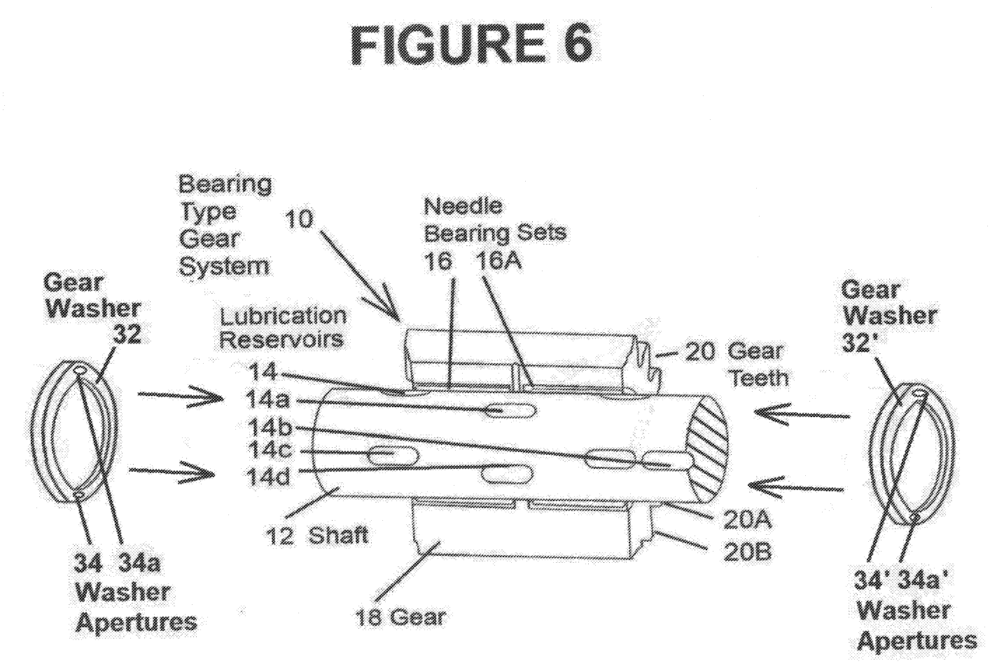

Turning briefly to FIG. 6, another feature of the bearing system, which can be present and further improve lubrication, is shown. The gear 18 has gear washers 32, 32′ in contact with the gear 18. The washers 32,32′ each have at least one aperture, and in this embodiment a respective pair of apertures 34, 34′, 34a, 34a′. When lubricant is applied to the gear 18 area, even more of the lubricant is able, by going through the apertures 34, 34′, 34a, 34a′, to get into the lubrication reservoirs 14, 14a, 14b, 14c, 14d and thereby the bearing sets, supplying them with more lubrication.

With the ability to use bearings, there is more contact area when torque is applied. This spreads the pressure over more of an operating area than with a bushing and pin type system, reducing wear. Further, this avoids lubrication issues of pin and bushing type systems, which by their very nature, push oil away from pressure points of contact, which naturally creates more wear on both the pin and bushing themselves than happens with the bearing system. In other words, this invention addresses the planetary lubrication problems in low profile crawler systems, allowing for an adequate oil system to planetary gears, making it possible to replace the pin and bushing system with a bearing system.

For truer rotation, the bearing type units operate with less clearance (0.0003 to 0.0006″) than the pin and bushing design (0.009 to 0.012″) and with this system, can now operate with such low clearances. The gear lubrication apertures 28, 28a at the center between the bearing sets 16, 16a help create an oil reservoir to let oil bleed into the bearing sets 16, 16a.

Bearings, on the other hand, because they have much tighter tolerances, have more contact area which causes considerably less friction than the pin and bushing system. The reduces friction, partly by reduction of torque, reduces wear on all components of bearings. This will reduce wear on pressure points and result in less energy needed to operate the crawler unit. The crawler unit will have less down time. This reduction of wear and the need for maintenance, in turn, increases the life of the unit.

The improved design of the shaft 12 for lubrication allows lubrication for the lower profile bearing units, overcoming the previous problem of restricted oil flow, enabling these units to finally successfully use bearings.

The exact sizes and number of reservoirs 14, 14a, 14b, 14c, 14d and apertures 28, 18a that are most suitable may vary with the type of machinery used and conditions, but can be determined by a user, through minimal testing. This is true of the sizes of the bearings 16, 16a as well, including diameter(s) and length(s) of bearings.

With the gear lubrication design disclosed herein, the bearing system can be properly lubricated. Accordingly, with this invention, a bearing type system can be used with the gears herein, and with reduced friction and wear on machinery, and can double or more the life of the friction-reducing assembly. As mentioned, this unit is designed to be used, and enhance the performance and life of, low profile machines, more specifically, machines for low seam underground mining.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the claims and summary are desired to be protected.

It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. A bearing type gear system comprised of:
a shaft,
a set of at least three lubrication reservoirs located on the surface of the shaft,
at least one bearing set comprised of a set of at least a pair of bearings,
and at least one gear with a set of gear teeth and further comprised of at least one bearing bed capable of supporting the at least one needle bearing set,
wherein the lubrication reservoirs are capable of collecting lubrication and assisting in distributing at least a portion of the lubrication to the at least one bearing set
and wherein the set of lubrication reservoirs are of a number and each of a location on the shaft so as to provide sufficient lubrication to the surface of the shaft and the at least one bearing set.

2. A bearing type gear system according to claim 1, wherein at least one lubrication reservoir is located on the shaft at each end of the gear along the shaft.

3. A bearing type gear system according to claim 1, wherein the lubricant is comprised of a lubrication oil.

4. A bearing type gear system according to claim 1, wherein the at least one gear is further comprised of at least one bearing wall protruding above the bearing bed.

5. A bearing type gear system according to claim 1, further comprised of at least one aperture extending through each respective at least one gear from one end at an outer surface of the at least one gear to the other end in the area of the shaft.

6. A bearing type gear system according to claim 5, wherein at least one aperture is at least a pair of apertures.

7. A bearing type gear system according to claim 5, wherein the at least one bearing set is at least a pair of bearing sets, and the at least one gear is further comprised of at least one bearing wall protruding above the bearing bed and capable of providing separation for the respective bearing sets,
and wherein the end of the at least one aperture in the area of the shaft is located at the top of the bearing wall.

8. A bearing type gear system according to claim 1, wherein the at least one bearing set is comprised of needle bearings.

9. A bearing type gear system according to claim 8, wherein the needle bearing set is further comprised of a backing securing the needle bearings within the bearing set.

10. A bearing type gear system according to claim 8, wherein the bearing type system with needle bearings operates with a clearance of 0.0003 to 0.0006″.

11. A bearing type gear system according to claim 1, wherein the set of lubrication reservoirs are distributed, at least in part, in a non-linear manner on the surface of the shaft.

12. A bearing type gear system according to claim 1, wherein the gear system is further comprised of a pair of washers in contact with the sides of the at least one gear,
and wherein each of the washers is further comprised of at least one aperture capable of allowing lubrication access past the respective washer and to the shaft.

13. A bearing type gear system according to claim 12, wherein the at least one aperture is a pair of apertures.

14. A low profile crawler drive for underground mining equipment comprised of a planetary gear system, which is comprised of,
a bearing type gear system comprised of:
a shaft,
a set of at least three lubrication reservoirs located on the surface of the shaft,
at least one bearing set comprised of at least one set of needle bearings,
and at least one gear with a set of gear teeth and further comprised of at least one bearing bed capable of supporting the at least one needle bearing set,
wherein the lubrication reservoirs are capable of collecting lubrication and assisting in distributing at least a portion of the lubrication to the at least one bearing set,
and wherein the set of lubrication reservoirs are of a number and each of a location on the shaft so as to provide sufficient lubrication to the surface of the shaft and the at least one bearing set.
